(19) United States
(12) Patent Application Publication
(10) Pub. No.: US 2020/0018572 A1
(43) Pub. Date: Jan. 16, 2020

(54) Retractable Barrier System

(71) Applicant: ProByte Services LLC, Spring, TX (US)

(72) Inventor: Pete Gonzales, Spring, TX (US)

(73) Assignee: ProByte Services LLC, Spring, TX (US)

(21) Appl. No.: 16/033,612

(22) Filed: Jul. 12, 2018

(51) Int. Cl. F41H 5/013; F41H 5/08; F41H 5/24; E06B 5/10

(52) U.S. Cl. CPC F41H 5/013; F41H 5/08; F41H 5/045; E06B 5/10; F41H 5/24

(57) ABSTRACT

A retractable barrier system and method for using the same is described herein. The retractable barrier system can include a retractable barrier made of one or more panels made of bullet resistant material and configured to fit across a doorway of a room. The panels can include one or more docking stations for housing a body armor unit. During a crisis event, the retractable barrier can be extending and secured across a doorway and multiple users can retrieve and don a body armor unit.

### BACKGROUND

### Field

This invention relates to the general field of barriers and shields used as protection against bodily harm. More specifically, this invention relates to the field providing bullet proofing means to people by providing structural and wearable material capable of preventing death.

### Description of the Related Art

In recent years, gun violence has received great scrutiny in the news and other media outlets. Statistics seem to indicate that death as a result of gun violence is on the rise, and active shooters have begun targeting large crowded areas, especially those areas known to be “gun free zones.” Most notably, shootings in heavily popular places such as schools, night clubs, and shopping malls have caught national media attention and have sparked great debate among the general populous and lawmakers alike.

As lawmakers continue to debate the implementation of laws to prevent such mass casualty shootings, others have focused on ways to reduce the number of casualties resulting from an active shooter situation, should another one occur. Historically, personal body armor has been used primarily for military and law enforcement personnel. However, due to recent mass shootings, civilians have begun seeking personal body armor and other means of personal protection for active shooter events.

A need exists for a bullet proof barrier system capable of providing both personal and group protection when a crisis event occurs.

### SUMMARY

This disclosure relates to a bullet proof barrier capable of sealing entry and exist point of a room and providing a staging/docking platform for personal body armor. This disclosure relates to one or more devices to provide protection for people in a crisis situation, including an active shooter situation. As history shows, an active shooter will arm himself with firearms and other weapons and use those items to inflict harm on other people. In most cases, the active shooter's intention is to harm or kill as many people as possible before law enforcement officials are able to restrain him. It is generally known that an active shooter may travel the halls of a building and while bystanders attempt to flee or seek shelter in a classroom.

A problem still exists in a building system situation (such as a school) because bullets fired from the hallway can still enter a room, leaving the people inside that room vulnerable. As such, the overall objective of this disclosure is to provide a means by which to seal off a room by manipulating a retractable barrier about the doorway of the room and to provide multiple options for bullet proof protection to the people inside the room.

In this disclosure, the term “seal off” is used to mean the prevention of a person, or persons, from being able to enter or leave the room about the entry or exit point previously established (i.e., the doorway). The term “seal off” is also used herein to mean that bullets or the harmful effects from any weapon deployed outside of the room is generally prevented from entering the room and harming those persons inside. When not in use, the retractable barrier can be folded or compacted into a position that does not interfere with the doorway or interior of the room. The retractable barrier can be mounted to the door frame about one side and can be manually or electronically maneuvered across the doorway. A latching mechanism can be provided about the opposite side of the doorframe and configured to “lock” the retractable barrier into the open position.

Another aspect of the invention is to provide a means of storing personal body armor in such a way as to allow multiple people to quickly and effectively retrieve the personal body armor when it is needed. The retractable barrier can be configured to include one or more docking stations for storing the individual body armor. The docking stations can be arranged in such a way as to provide quick and easy access to the one or more persons retrieving the body armor.

### BRIEF DESCRIPTION OF THE DRAWINGS

FIG. 1 depicts a front side perspective view of the retractable barrier, as shown and described herein.

FIG. 2 depicts a close-up view of a docking station and corresponding body armor, as shown and described herein.

FIG. 3 depicts a perspective view of a body armor unit, as shown and described herein.

FIG. 4 depicts a top side view of the retractable barrier in the collapsed position, as shown and described herein.

FIG. 5 depicts a top side view of the retractable barrier in a partially open position, as shown and described herein.

FIG. 6 depicts a top side view of the retractable barrier in the open position, as shown and described herein.

FIG. 7 depicts a close-up view of the locking mechanism of the retractable barrier, as shown and described herein.

FIG. 7a depicts another close-up view of the locking mechanism of FIG. 7, as shown and described herein.

FIG. 8 depicts a close-up view of an alternative locking mechanism of the retractable barrier, as shown and described herein.

FIG. 8a depicts another close-up view of the alternative locking mechanism of FIG. 8, as shown and described herein.

### DETAILED DESCRIPTION

The disclosure made here is described in the context of providing a barrier to seal the entry and exit point of a room. In most cases, that entry and exit point is most often a door to the room and will be described in that context. However, it should be understood that the barrier described herein can be manipulated or reconfigured to fit across any opening in any wall of the room (i.e., a window, and air vent, etc.). The purpose of the retractable barrier 100 is to prevent people and objects from traveling into our out of the room. As such, the size of the retractable barrier 100 is often slightly larger than the door itself, though not required. Any reference to the “door” or “door way” should be given it broadest possible meaning, and it should be understood that such references are intended to provide context by which to understand the disclosed device,

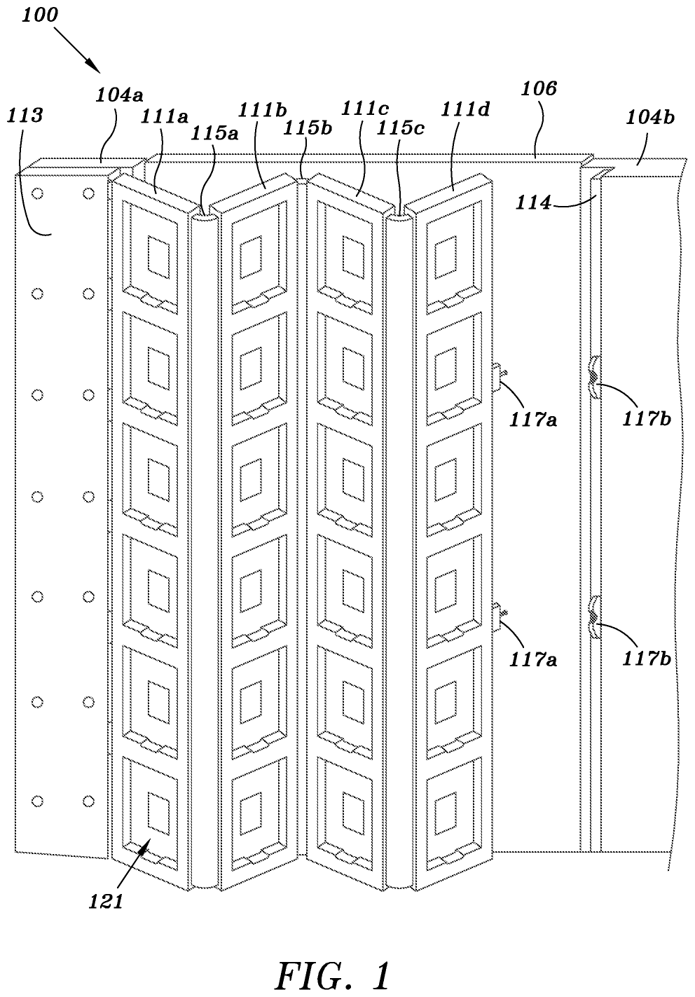

FIG. 1 depicts a front side perspective view of the retractable barrier 100. The retractable barrier 100 can include one or more panels 111a-d (four are shown) connected to one another to create a barrier. The retractable barrier 100 can also include one or more mounting brackets 113, one or more receiver mounts 114, one or more panel connectors 115, one or more locking mechanisms, and one or more armor docking stations 121 configured to house one or more personal body armor units 123, or any combination thereof.

As shown in FIG. 1, each panel 111a-d can form one of the vertically extended segments of the retractable barrier 100. The retractable barrier 100 can be fixed to a wall or the frame of a doorway via a mounting bracket 113. In some embodiments, the retractable barrier 100 can be attached to, or built into, the existing door frame. In other embodiments, a separate frame or a plurality of frame members can be put into place to house the retractable barrier components. Generally, the mounting bracket 113 can extend the full height of the door frame and be connected thereto via one or more connectors, A corresponding receiver mount 114 can be connected to the opposing side of the door frame and configured to house a receiver locking mechanism 117b. The one or more connectors can include generally acceptable connection means, including, for example, bolts, screws, nails, and welding.

A first panel 111a can be connected to a first side of the door frame 104a via the mounting bracket 113. In most embodiments, the mounting bracket 113 will provide the entire structural support to the retractable barrier 100 so that the barrier is hung a small distance from the ground. That is to say, similar to a door, the retractable barrier 100 is not required to rest on the ground for structural support, whether in the open or closed position. An alternative embodiment could provide a track mounted to the top of the door frame to provide additional support and to bear some of the weight of the retractable barrier 100.

A plurality of panels can extend from the first panel 111a and ending with a terminus or last panel 111d. As shown in the figures, a second panel 111b can be connected to the first panel 111a via one or more first connector 115a, A third panel 111.c can be connected to the second panel 111b via one or more second connectors 115b. A fourth panel 111d can be connected to the third panel 111c vial one or more third connectors 115c. Though only four panels 111 are shown, in an alternative embodiment, any number of panels can be included in the retractable barrier 100. For example, one or more panels, two or more panels, three or more panels, four or more panels, five or more panels, six or more panels, seven or more panels, eight or more panels, nine or more panels, or ten or more panels can be included in the retractable barrier.

Each panel 111a-d can be connected to the neighboring panel by one or more connectors or connection means. As shown, the connection means can include a flexible material connecting the full length of each panel. One or more alternative means can include brackets, fixings, cords, cloth material, and hinges of all kinds. In at least one embodiment, the panels can be connected directly to one another.

The panels 111 can be made of a bullet proof or bullet resistant material. In some cases, the panels 111 can be made of a steel sheet having a thickness necessary to provide a bullet proof function to the retractable barrier 100. In other embodiments, the panels 111 can be made of or at least compose one or more layers of another bullet proof material, for example, Keviar®, Kevlar KM2®, Gold Flex®, Spectra Shield®, Dyneema®, Twaron™, or composite metal foam (“CMF”).

The retractable barrier 100 can also include one or more latching mechanisms 117. The purpose of the latching mechanism 117 is to secure and lock the retractable barrier 100 into the open position, thereby sealing of the door 106 from entry or exit. The locking mechanism can include a first piece 117a disposed on the distal panel 111d and a corresponding second piece 117b disposed in the door frame 104b or an optional barrier frame (not shown) mounted on the wall.

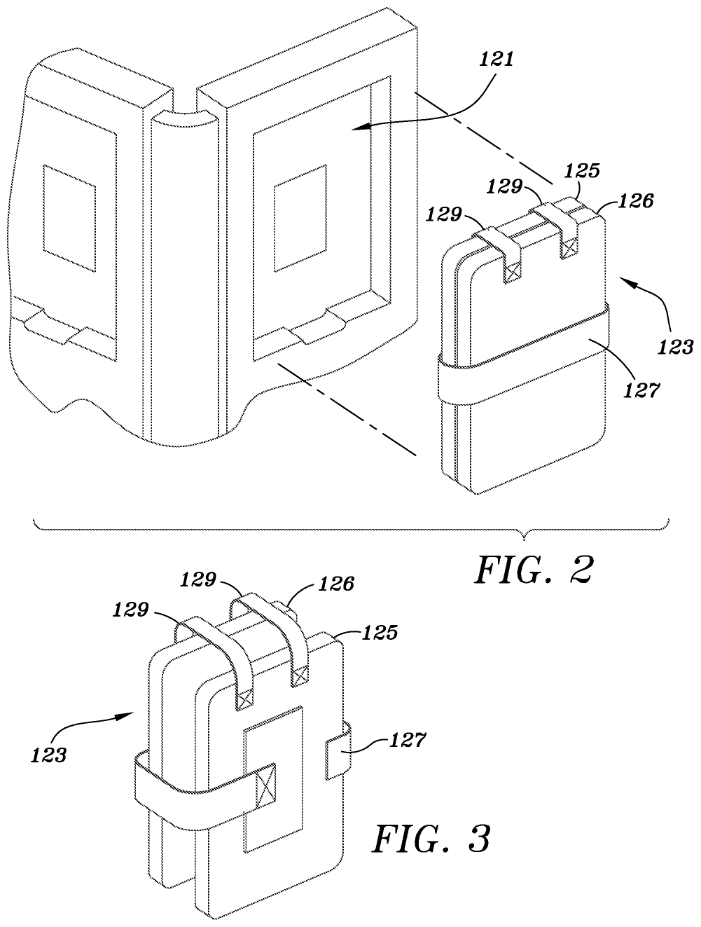

FIG. 2 depicts a close-up view of a docking station 121 and a corresponding body armor unit 123. The docking station 121 can be disposed on the interior or “front” side of the retractable barrier 100, so that, when the barrier is partially or fully open, a user can access the body armor unit 123. As shown, each docking station 121 can be generally rectangular in shape and be structured as an indention in the panel 111 of the retractable barrier 100. In this configuration, the corresponding body armor unit 123 can also be generally rectangular in shape and sized appropriately so that it fits within the docking station 121. The body armor unit 123 can be stored or “docked” while in a collapsed arrangement.

One or more methods of securing the body armor unit 123 within the docking station 121 can be used. For example, a Velcro® patch can be placed on the body armor unit 123 and a corresponding Velcro® patch can be placed within the docking stations. In another example, one or more buttons, magnets, or clasps can be disposed on the body armor unit 123 and the corresponding pieces can be disposed on or in the docking station 121 in a configuration capable of keeping the unit 123 in place until the user retrieves it.

FIG. 2 also depicts the body armor unit 123 in a collapsed arrangement and FIG. 3 depicts a perspective view of the body armor unit 123 in an expanded arrangement. The body armor unit 123 can include a front shield 125 and a rear shield 126, a torso strap 127 and one or more shoulder straps 129 (two are shown). As shown in FIG. 2, to compress or consolidate the body armor 123 for storing in the docking station 121, the torso strap 127 can be wrapped around the front and back shields 125, 126 in a tightened manner via Velcro®. As a user retrieves the body armor unit 123, he can approach the wall and take hold of the unit 123 to remove it. As shown, a finger grip or indention can be disposed in one of the side walls of the docking station 121 so that the user can more easily grip the body armor unit 123. Once removed, the user un-Velcro® or otherwise loosen the torso strap 127, place the unit 123 over his head so that his head comes between the first and second shoulder straps 129, and position the front shield 125 about his chest and the rear shield 126 about his back. The user can then secure the unit 123 to his body via the torso strap 127 by pulling the torso strap 127 around his body and reattaching to the Velcro® patch on the front or back shield 125, 126.

The body armor units 123 can come in a variety of shapes and sizes, including those body armor units already on the market, commonly referred to as bullet-resistant and/or bullet-proof vests. In other embodiments, a special design and material composite can be created for the body, armor unit 123, as discussed above. The purpose of the docking stations is to provide a storage means for a plurality of body armor units 123, so that when an active shooter situation is taking place, a plurality of people can quickly approach the retractable barrier 100 to retrieve and don the body armor unit 123. With this in mind, a reader could reasonably interpret the docking stations 121 to come in a variety of embodiments, including hooks, pouches, cubicles, or other embodiments containing means for storing the corresponding body armor units 123. Similarly, because the body armor units 123 can come in a variety of shapes, sizes, designs, and configurations, the docking stations 121 can be tailor made to suit and properly store the selected body armor units 123.

The body armor unit 123 can be made of a plurality of materials but would include at least one material determined to be “bullet-proof” or “bullet-resistant.” Bullet resistant materials can include aramid fibers, ultra-high-molecular-weight polyethylene (“UHMWPE”) and subset of the thermoplastic polyethylene (also known as high-modulus polyethylene, (“HMPE”)) commonly used to fabricate lightweight armor. The body armor units 123 can include commercially available materials including Kevlar® (polymer poly-para-phenylene terephthalamide), Kevlar KM2®, Gold Flex®, Spectra Shield®, Dyneema®, and Twaron™. The body armor unit 123 and portions of the retractable barrier 100 (including the panels and connectors) can also be made of, in whole or in part, of composite metal foam, recently developed by Afsaneh Rabiei, a professor of mechanical and aerospace engineering at North Carolina State University. A composite metal foam is a cellular structure consisting of a solid metal (frequently aluminum) with gas-filled pores comprising a large portion of the volume. The pores can be sealed (closed-cell foam) or interconnected (open-cell foam).

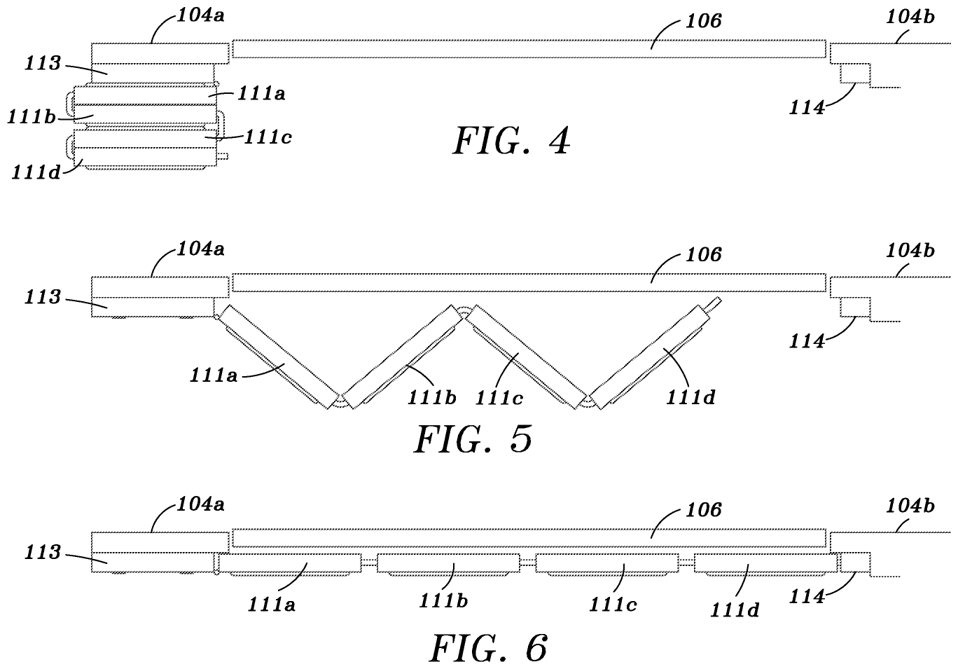

FIG. 4 depicts a top side view of the retractable barrier 100 in the collapsed position, FIG. 5 depicts a top side view of the retractable barrier 100 in a partially open position, and FIG. 6 depicts a top side view of the retractable barrier 100 in the open position. As previously discussed, the retractable barrier 100 can be mounted to the door frame 104a or wall on the side of the door 106 via the mounting bracket 113. The retractable barrier 100 can be stored in the collapsed or folded position (FIG. 4) along a first side of the door/door frame area. Throughout this disclosure, a reader should understand that the retractable barrier system is intended to be mounted to or near a doorway so that, when a crisis event is detected or identified, any person can maneuver the retractable barrier across the doorway and secure it into the open position so that the retractable barrier can function as a bullet proof barrier for persons on the other side. As such, the retractable barrier can be folded, rolled, or collapsed into the collapsed configuration so that it is out of the way of the door while it is not in use. Many storage options can be imaged for this storage configuration, as users would most likely prefer the collapsed barrier to be out of the way and at least partially hidden from sight as a matter of convenience and preference.

At any given time, a crisis event may occur and a person in the vicinity will elect to close the retractable barrier to benefit from its function as a bullet proof/resistant shield. More specifically, to form a barrier between the user and the identified danger. The “crisis event” or “crisis situation” can include any and all situations that pose a danger to the user and other bystanders. For example, and as discussed herein, a crisis event can include an active shooter situation, where the active shooter is using a firearm or other weapons to harm one or more persons. The user and bystanders can position themselves inside the room and maneuver and secure the retractable barrier across the doorway, thereby creating a barrier between themselves and the danger. If the danger is an active shooter or person possessing a firearm, the retractable barrier containing bullet resistant material can act as a shield to protect them from the threat of bodily harm by stopping bullets and other projectiles from penetrating the barrier. Moreover, the user/bystanders can also retrieve the body armor units from the retractable barrier and don them for added protection. In some active shooter situations, it becomes necessary for the persons positioned in a room to leave the room to travel to a new, and perhaps more secure, location. In this event, continuing to wear the body armor units will provide protection to the users even though the retractable barrier protection is no longer in use. The users can retrieve the body armor units from the retractable barrier at any time; the barrier does not have to be in the open configuration for retrieval of the body armor units.

When a user elects to open the retractable barrier 100, he can take hold of one or more of the panels 111a-d and extend the retractable barrier 100 across the doorway. In most instances, the door 106 to the room will be shut (as shown) before opening the retractable barrier 100, but that is not always the case and is not required for the retractable barrier 100 to serve its purpose. When fully opened (FIG. 6), the retractable barrier 100 will extend across the entire doorway to form a complete barrier between the outside and inside of the doorway.

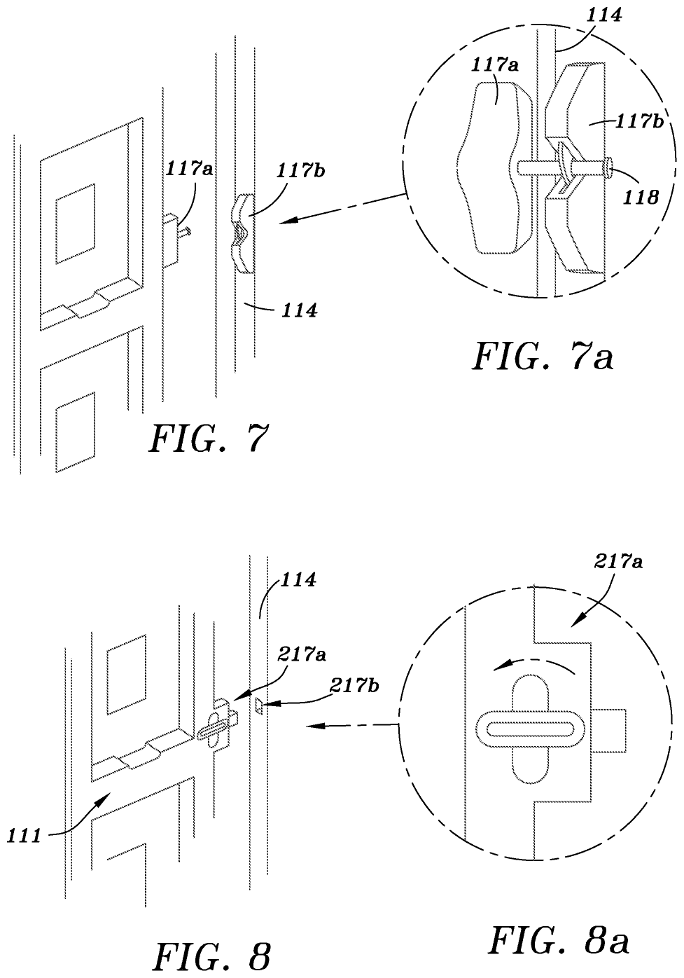

The retractable barrier can then be secured into the open position, most often by activating or using a locking mechanism. FIG. 7 depicts a close-up view of the locking mechanism 117 of the retractable barrier 100 and FIG. 7a depicts a close-up view of the locking mechanism 117 of FIG. 7. To lock or secure the retractable barrier 100 into the open position, the user can manipulate the locking mechanism 117a by inserting the pin 118 into the latch 117b. As shown in FIG. 1, a plurality of locking mechanisms can be used.

FIG. 8 depicts a close-up view of an alternative locking mechanism of the retractable barrier and FIG. 8a depicts another close-up view of the alternative locking mechanism of FIG. 8. The locking mechanism 217 can include a lock insertion pin configured to be received by a receiver port stabled in the frame receiver mount 114. The locking mechanism can be quickly locked by turning the knob or latch to the locked position; accomplished as shown in FIG. 8a by turning in a counter-clockwise direction.

It is the intention of the retractable barrier system to provide bullet proof protection to as much of the person's body as possible and to as many people as possible. Therefore, a reader can understand the advantage this system would provide to large populations of people concentrated within a building system.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account numerical error and variations that would be expected by a person having ordinary skill in the art.

While the foregoing is directed to embodiments of the present invention, other and further embodiments of the invention may be devised without departing from the basic scope thereof, and the scope thereof is determined by the claims that follow. Moreover, an ordinary person having skill in the art should understand that this invention is applicable in a many types of body armor units and bullet proof barriers or shields, and the invention is not limited to a class room setting.

What is claimed is:

1. A retractable barrier system, comprising:
a retractable barrier having two or more panels connected to one another;
one or more docking stations disposed on the one or more panels and configured to house a body armor unit.

2. The retractable barrier system of claim 1, further comprising a mounting bracket providing structural support to the retractable barrier.

3. The retractable barrier system of claim 1, further comprising a mounting bracket for securing about a first side of a door frame and providing structural support for the retractable barrier to be extended across a doorway.

4. The retractable harrier system of claim 3, wherein secured to a receiver mount disposed on a second side of the door frame.

5. The retractable barrier system of claim 4, wherein the panels and body armor unit comprise a bullet proof material.

6. The retractable barrier system of claim 4, wherein the panels and body armor unit comprise composite metal foam.

7. The retractable barrier system of claim 1, wherein the body armor unit comprises a front shield, a rear shield, and at least one strap connecting the front and rear shield.

8. The retractable barrier system of claim 5, wherein the body armor units are removably attached to the docking station.

9. A retractable barrier system, comprising:
a retractable barrier having two or more panels made of a bullet resistant material and connected to one another; and
one or more docking stations disposed on at least one of the panels and configured to house a body armor unit, wherein the body armor unit comprises bullet resistant material.

10. The retractable barrier system of claim 9, wherein the bullet resistant material includes a composite metal foam.

11. The retractable barrier system of claim 9, Wherein the body armor unit comprises a front shield, a rear shield, a torso strap, and one or more shoulder straps.

12. The retractable barrier system of claim 9, further comprising a mounting bracket for securing the retractable barrier system to a doorway.

13. The retractable barrier system of claim 9, wherein one or more docking stations can be disposed on a first panel.

14. The retractable barrier system of claim 13, wherein a connecting device can be used to retain the body armor unit within the docking station.

15. A method for using a retractable barrier system, comprising:
mounting the retractable barrier system to a doorway, wherein the retractable barrier system comprises:
a mounting bracket,
a retractable barrier extending from the mounting bracket and comprising one or more panels, and
one or more docking stations housings one or more body armor units, wherein the body armor units comprise a front shield, a rear shield, a torso strap, and one or more shoulder straps;
storing the retractable barrier in a folded position;
extending the retractable barrier across the doorway and securing it to receiver mount; and
removing a body armor unit and securing the body armor unit about a user's torso.

16. The method of claim 15, wherein the body armor unit comprises a front shield, a rear shield, a torso strap, and one or more should straps and
wherein securing the body armor unit to a user's torso comprises:
maneuvering the body armor unit over the user's head such that a first shoulder strap comes to rest on the user's first should and a second shoulder strap comes to rest on the user's second shoulder such that the front shield comes to rest on the user's front body and the rear shield comes to rest on the user's back, and
securing the body armor unit in place by wrapping the torso strap around the user's body and securing the torso strap to a connector.

17. The method of claim 15, wherein the user can elect to extend the retractable barrier across the doorway after identifying a crisis event.
